(19) United States
(12) Patent Application Publication
(10) Pub. No.: US 2025/0269331 A1
(43) Pub. Date: Aug. 28, 2025

(54) INORGANIC MEMBRANES AND METHODS OF FABRICATION THEREOF

(71) Applicant: National University of Singapore, Singapore (SG)

(72) Inventors: Chen ZHANG, Singapore (SG); Ghim Wei HO, Singapore (SG)

(21) Appl. No.: 18/614,216

(22) Filed: Mar. 22, 2024

(30) Foreign Application Priority Data
Feb. 26, 2024 (SG) 10202400521Y

(51) Int. Cl. B01D 67/00; B01D 71/02

(52) U.S. Cl. CPC B01D 67/0039; B01D 71/022; B01D 2323/42; B01D 2323/62

(57) ABSTRACT

This disclosure concerns a method of fabricating an inorganic membrane, comprising coalescing inorganic particles at an air-liquid interface of a vessel in order to form the inorganic membrane, wherein inner walls of the vessel is configured to repel the inorganic nanoparticles.

### RELATED APPLICATIONS

This application claims the benefit of and priority to Singaporean Patent Application No. 10202400521Y, filed Feb. 26, 2024, the contents of which are hereby incorporated by reference in their entirety.

### TECHNICAL FIELD

The present disclosure relates, in general terms, to inorganic membranes and their methods of fabrication thereof.

### BACKGROUND

The market for inorganic membranes is anticipated to increase in the near future. Inorganic membranes, especially silica, porous glass, crystalline zeolites, microporous beryllium oxide powders and carbon membranes garner a lot of attention due to their capability in having both higher permeability and selectivity, and can have a superior performance over glassy polymeric membranes. Inorganic membranes can also operate at higher temperatures compared to organic membranes for their application to gas separation processes where the temperature can go up to 300° C. Molecular sieve membranes are chemically resistant to organic solvents, chlorine and other chemicals and more resistant than organic membranes. This property can be very helpful for water treatment applications where water is dosed with chlorine and/or other disinfectants and organic membranes could fail. Also chemical resistivity allows inorganic membranes to be cleaned and washed regularly with different solvents and anti-scaling agents. Additionally, inorganic membranes are not vulnerable to microbial attack, and they can be mechanically robust.

In addition to conventional structural-based filtration capabilities, inorganic membranes hold promise in leveraging the optical, electrical, magnetic, and other functionalities of their matrix inorganics, thereby spawning entirely new applications in sensing, optical filtering, memristors, ion conductors, and beyond.

Different from the organic/polymer membranes, which can be easily obtained from diverse top-down moldings and/or bottom-up syntheses, fabricating an inorganic membrane is very hard. The inherent brittleness present in almost all inorganic materials dictates that they cannot be processed into membrane forms through traditional techniques such as extrusion, rolling, or stretching. Moreover, unlike the organic monomers, there are few surface unsaturated linkages on the inorganic building blocks. This fundamentally determines that inorganic materials cannot obtain corresponding inorganic membranes through similar interface polymerization reactions from bottom-up syntheses.

The preparation of inorganic membranes often starts with a support or a mold. As such, the preparation is highly dependent on the substrate and may show some variance in a large scale commercial setting.

Up to now, only a few specific inorganic membranes were circuitously derived from the pre-deposited films by selective removal of the sacrificial substrates. However, this method requires a high level of interface compatibility between the membrane material and the substrate material, limiting the range of inorganic membrane types that can be accessible.

It would be desirable to overcome or ameliorate at least one of the above-described problems.

### SUMMARY

The present disclosure provides a method of fabricating an inorganic membrane, comprising coalescing inorganic particles at an air-liquid interface of a vessel in order to form the inorganic membrane, wherein inner walls of the vessel is configured to repel the inorganic nanoparticles.

In some embodiments, the method comprises coalescing the inorganic particles via Brownian motion to form inorganic clusters, and coalescing the inorganic clusters via capillary attraction (Cheerios effect) to form the inorganic membrane.

In some embodiments, the inorganic particles are inorganic nanoparticles characterised by a size of about 2 nm to about 1000 nm.

In some embodiments, the inorganic clusters are characterised by a size of about 0.5 μm to about 100 μm.

In some embodiments, the inner wall is configured to have a surface energy of less than about 36 dynes/cm.

In some embodiments, the inner wall comprises a coating of a polymer or a hydrogel.

In some embodiments, the inner wall comprises poly(vinyl acetate), polyacrylamide (PAAm), polyacrylic acid (PAA), poly(N-isopropylacrylamide) (PNIPAAm), polyethylene glycol (PEG), or a derivative thereof.

In some embodiments, the inner wall comprises poly(vinyl alcohol-co-vinyl acetate) characterised by a degree of hydrolysis of about 70% to about 90%.

In some embodiments, poly(vinyl acetate) or a derivative thereof is characterised by a molecular weight of about 1400 g/mol to about 2000 g/mol.

In some embodiments, the inorganic particles are formed via precipitation, hydrolysis or redox reaction.

In some embodiments, the inorganic particles are selected from the group consisting of elemental substances, oxides, sulfides, halides, hydroxides, metallates, nonmetallates and coordination polymers.

In some embodiments, the inorganic particles are selected from S, Pd, Ag, Pt, Au, TiO₂, MnO₂, RuO₂, CeO₂, WO₃, FeS, Cu₈S₅, ZnS, Dy₂S₃, WS₂, SmF₃, AgCl, BaClF₃, CuBr, PbI₂, Al(OH)₃, FeOOH, Cu(OH)₂, Cd(OH)₂, La(OH)₃, Zn(AlO₂)₂, BiVO₄, Ag₂CrO₄, CaMoO₄, In₂SnO₅, CaCO₃, Zn₂SiO₄, Mg₃(PO₄)₂, Cu₂SO₃, Ag₂SeO₃, K-containing Prussian blue, Fe(iii)-polyphenol tannic acid complex, ZIF-67, Ni(ii)-dimethylglyoxime complex and Cu(ii)-oxalic acid complex.

In some embodiments, the method further comprises mixing a first solution comprising a first inorganic precursor with a second solution comprising a second inorganic precursor in the vessel.

In some embodiments, the inorganic membrane is formable in an absence of agitation.

In some embodiments, the inorganic membrane is formable in less than about 30 min.

In some embodiments, the inorganic membrane comprises a quasi-bicontinuous network of inorganic material.

In some embodiments, the inorganic membrane is isotropic.

In some embodiments, the inorganic membrane is multifractal.

In some embodiments, the inorganic membrane is characterised by at least one through hole.

In some embodiments, the inorganic membrane is characterised by a circularity and geometrical convexity.

In some embodiments, the inorganic membrane is characterised by a thickness of about 50 nm to about 500 nm.

### BRIEF DESCRIPTION OF THE DRAWINGS

Embodiments of the present invention will now be described, by way of non-limiting example, with reference to the drawings in which:

FIG. 1A. | SLIS-induced conversion of the nucleation preference in aqueous solution. Sketch of the free energy change (ΔG) normalized to the interfacial tension between the liquid medium and the solid nucleus (γᵢₙ) through homogeneous nucleation (homo, upper meshed surface) and heterogeneous nucleation (hetero, bottom surface), as a function of the critical nucleus volume and the contact angle with the corresponding interface. The heterogeneous situation corresponds to two nucleation locations, namely, the solid-liquid interface and the air-liquid interface with the contact angles of θ and φ, respectively.

FIG. 1B. Schematic illustration of three possible nucleation locations, with the highlighted nucleation priority in a container-held solution system before and after SLIS treatment.

FIG. 1C. AFM force-distance curves for the bare and SLIS-treated glass surfaces measured under water. The two insets zoom in on the force-sensing regions and show the corresponding energy changes for the approach and withdrawal process, respectively. Scale bars are 5 nm (approach), 20 nm (withdraw) and 25 nN (main plot).

FIG. 1D. Microstructure diagrams and PDFs (G(r)) of the PVAAc hydrogel coating under free swelling and compressive load. Note that the O—O distance in the hydrogel system results from a superimposed contribution from the relatively short OW—OW (O in water molecule) and the relatively long OW—OP (O in the OH group of the PVAAc network) distance. The pair correlation at about 4.8 A belongs to OW—CP (C in the PVAAc network) distance. The observed decrease in O—O distances when the hydrogel coating is compressed validates the lower proportion of the OW—OP contribution, which is caused by the decreased density of hydrogen bonds between water and the PVAAc network. This confirms an enhancement in the structural order degree of the hybrid system consisting of the PVAAc network and water molecules, namely, the reduced entropy of mixing (ΔS<0), under a compressive loading.

FIG. 2A. | From the pilot Ag membrane to unlocking a colourful membrane library. Digital photos of the completed silver mirror reaction performed in the untreated and SLIS-treated vessels.

FIG. 2B. Digital photo of the as-prepared Ag membrane suspended by a varnished wire ring. Scale bar is 1 cm.

FIG. 2C. Sheet resistance mapping at 20×20 points on the Ag membrane with the test area of 10×10 mm². Scale bar is 2 mm.

FIGS. 2D-2E. Top view and side view SEM images of the Ag membrane. The insets respectively zoom in on a typical membrane wrinkle in FIG. 2D and the membrane edge in FIG. 2E. Scale bars are 200 μm (FIG. 2D), and 5 μm (FIG. 2D inset), 10 μm (FIG. 2E), 1 μm (FIG. 2E inset).

FIG. 2F. Typical experimental loading curve of the Ag membrane and the curve fitting to the theoretical equation. The inset highlights that the curve between load and deflection approaches cubic behaviour at high loads.

FIG. 2G. Optical micrographs of 40 freestanding membranes prepared in the SLIS system, covering eight categories of materials, that is, elementary substances (S, Pd, Ag, Pt and Au), oxides (TiO₂, MnO₂, RuO₂, CeO₂ and WO₃), sulphides (FeS, Cu₈S₅, ZnS, Dy₂S₃ and WS₂), halides (SmF₃, AgCl, BaClF₃, CuBr and PbI₂), hydroxides (Al(OH)₃, FeOOH, Cu(OH)₂, Cd(OH)₂ and La(OH)₃), metallates (Zn(AlO₂)₂, BiVO₄, Ag₂CrO₄, CaMoO₄ and In₂SnO₅), nonmetallates (CaCO₃, Zn₂SiO₄, Mg₃(PO₄)₂, Cu₂SO₃ and Ag₂SeO₃) and coordination polymers (KPB, K-containing Prussian blue; Fe-taa, Fe(iii)-polyphenol tannic acid complex; ZIF-67; Ni-dmg, Ni(ii)-dimethylglyoxime complex and Cu-oxa, Cu(ii)-oxalic acid complex). The micrographs were purposefully focused on the wrinkling membrane areas to highlight their flexibility. The insets are the digital photos of the corresponding membranes suspended on a copper ring with a diameter of 4 mm. The symbols in the upper-right corners indicate the reaction types used to prepare the membrane. Scale bar is 200 μm.

FIG. 3A. | Kinematic-controlled membrane growth in the SLIS system. Time-resolved reflectance spectra of the solution surface throughout the Ag membrane formation. The numbered arrows indicate the critical structural evolutions and provide index support for subsequent characterizations. a.u., arbitrary units.

FIG. 3B. Schematic of the timeline showing the temporal kinematics of the floating units (particles or clusters) during membrane growth.

FIG. 3C. Typical SEM image of the nascent floating Ag particles collected at 0.93 s after initiating the reaction. Their disordered distribution is confirmed by the inset 2D autocorrelation analysis result. Scale bar is 1 μm.

FIG. 3D. Autocorrelation analyses for the time series of the attraction between the suspended AFM tip and the air-liquid interface as illustrated in the inset. In contrast to blank water, the intensity fluctuation for the reaction solution collected at 0.93 s indicates the 2D Brownian motion of the floating Ag particles.

FIG. 3E. Multifractal spectra of the solid network and the complementary through-hole network in the (quasi-)bicontinuous Ag network as illustrated in the inset pseudo-colour TEM image. The dashed lines help to visually identify the dimension f(a)=a. Scale bar is 500 nm (inset).

FIG. 3F. Typical high-resolution TEM image of the polycrystalline Ag network with recognizable four regions as highlighted by the lower-right schematic. The fast Fourier transformed images are shown in the respective region-corresponding colours. Scale bar is 5 nm.

FIG. 3G. Calculated collision energy against the sizes of the two mutually attracted Brownian clusters driven by the Cheerios effect, which respectively composed of n1 and n2 Ag particles as illustrated in the top diagram.

FIG. 3H. Time-course coverage factors and fractal dimensions for different membrane-forming systems, involving various building blocks of discal AgCl, hemispherical BiVO₄ and claviform Ag₂CrO₄ particles as shown in the inset SEM images. The bottom pseudo-colour microphotographs depict their corresponding (quasi-) bicontinuous networks, respectively. The arrows indicate the moment when the Cheerios effect starts to work. Scale bar is 5 μm (insets).

FIG. 4A. | General synthetic methodology and extension of complexity for the SLIS-mediated membrane. Phase diagram based on the geometrical description of the patterned floating Ag solids evolving from different reaction temperatures (T) and initial concentrations of [Ag(NH₃)₂]+(log 2(c)). GT models for phases, including node islands (NI), clique islands (CI), open network (ON) and closed network (CN), are presented in the same colour as that of the corresponding phase regime. The spheres show the local temperature and concentration-determined membrane thickness indicated by the left colour bar.

FIG. 4B. Criterion for the spontaneous formation of Brownian clusters with specific size depending on the particle radius and density. The coloured surface denotes the smallest particle number in a Brownian cluster that may smoothly expand.

FIG. 4C. Criterion for the spontaneous aggregation of two Brownian clusters/particles. The space is spanned by their sizes (n1, n2) and initial distance (d, right colour bar), which collectively determine a family of curved surfaces Q, whereas the reaction temperature T, the building unit's radius r and density p dictate the position of a mobilizable dashed plane ψ. The region of Q≥ψ represents the desired spontaneous aggregation. These intersecting lines, which predict the critical n1 and n2 for varied cases of initial distance, are projected to the left plane. Note that, when d is larger than the capillary length of water λc (around 2.7 mm at room temperature), the determined curved surface will not intersect the plane.

FIG. 4D. Phase diagram based on the density N and radial growth velocity G of the building blocks. The shaded region at the top-right corner is not available owing to the practical constraint of finite reactant supply. The colour bar shows the duration of the feedstocks' depletion.

FIG. 4E. Digital photos of three multiplex membranes derived from simple Ag membrane, including Ag₂S·Ag mixed membrane, CeO₂—Ag bicontinuous membrane and FeOOH/Ag stacked membrane, whose structures are illustrated in the top-left schematics, respectively. Scale bars, 1 cm.

FIGS. 5A-5H. | Universality of the SLIS strategy for diverse types of vessel routinely used in the lab to perform aqueous reactions. The polymer based substrates include polyethylene (PE) (FIG. 5A), polytetrafluoroethylene (PTFE) (FIG. 5B), polypropylene (PP) (FIG. 5C), polystyrene (PS) (FIG. 5D) and polyethylene terephthalate (PET) (FIG. 5E). The ceramic-based substrates include silicon (FIG. 5F) and sapphire (FIG. 5G). The metal-based substrate includes platinum (FIG. 5H). Their molecular or crystalline structures are shown in a1-h1, respectively. a2-h2, Contact-angle images for a sessile water droplet on the substrates, visually showing their relative hydrophilicity. a3-h3, AFM force-distance curves for bare and PVAAc-coated substrate surfaces measured in air and under water, respectively. The insets zoom in on the force-sensing regions in the force-distance curve for the bare substrate-liquid water interface during approach and withdraw processes and present the related potential energy changes (ΔE).

FIG. 6A. | Further information on the inorganic membrane library constructed by the SLIS strategy. Digital photos of the reaction systems with freshly prepared membrane floating on the solution surface.

FIG. 6B. Chemical elements involved in the inorganic membrane library constructed using the SLIS strategy. The light shade indicates that the element has been involved to constitute specific membrane in the presented membrane library. The dark shade with black font denotes all the potential elements that can be theoretically further incorporated into the membrane library because each of them can find the analogue in chemical property in the as-involved ones. The dark shade with white font indicates all the elements that are not available for SLIS synthesis owing to their extremely expensive price, chemical inertness and/or radioactive hazard.

FIG. 6C. Chord diagram showing the potential multifield-coupling energy-conversion pathways among these functional membranes presented in the library. The available energy forms are mechanical, light, thermal, electric, magnetic and chemical energy.

FIG. 7A. | Critical developments of structural evolution during Ag membrane growth in the SLIS system. Voronoi texture-meshed typical SEM images of the floating solid collected at 4.32, 17.1 and 53.5 s. The red dot indicates the centre of each Brownian cluster. The colour of each cell denotes the coordination number, as indicated in the right colour bar. The colour of the boundary highlights the connectivity between the adjacent cells, that is, blue denotes unconnected cells and yellow denotes connected cells that are caused by the cross-domain growth of the Brownian cluster. Scale bars are 1 μm.

FIG. 7B. Typical SEM images with pseudo colours of the floating Ag membrane collected at 15, 20.5, 25.5 and 30 min. The numbers above these images (FIG. 7A and FIG. 7B) help to identify the corresponding critical moments as indicated in FIG. 7A.

FIG. 7C. Statistical map of the circularity against the logarithmic area for the through holes extracted from the typical SEM images in FIG. 7B. The top and right plots are the density distributions along the axes of the through-hole area and the circularity, respectively.

FIG. 7D. Violin plots to show the statistical changes in the solidity (left) and the minimum Feret diameter (right) of the through holes after the formation of the (quasi-)bicontinuous framework. The scatter line in right plot shows the corresponding evolution in the coverage factor of the floating Ag membrane.

FIG. 7E. Typical structures of the extracted through holes forming at the corresponding critical moments. Starting from the highly connected network structure, the through holes can gradually evolve into a low-circularity closed-hole structure, then to a high-circularity closed-hole structure and an eventual compact structure, accompanied by the continuously sharpened size distribution and increased geometrical convexity. To aid in visual identification, all the scatters, rugs, lines, violins and the extracted hole structures are respectively coloured with the same colours of the corresponding SEM images in FIG. 7B. Scale bars are 1 μm.

FIGS. 8A-8F. | Confirmation of the actual position of the as-prepared floating Ag membrane on the aqueous surface. 2D maps of the local adhesion force (FIG. 8A, FIG. 8D), interfacial stiffness (FIG. 8B, FIG. 8E) and rupture distance (FIG. 8C, FIG. 8F) for the interface between air and the on-site floating Ag membrane (FIGS. 8D-8F, 30 min after igniting the silver mirror reaction in the SLIS system) in comparison with that of the air-deionized water interface (FIGS. 8A-8C). The maps represent the results of AFM indentation measurements performed at 25 different positions on the two kinds of interface. The colour-coded plots represent variations of the parameters of interest as indicated in the left colour bars.

FIGS. 8G-8I. Statistical variations for the measured adhesion force (FIG. 8G), interfacial stiffness (FIG. 8H) and rupture distance (FIG. 8I) extracted from the corresponding 2D maps. All the points are presented in scatters along with a Gauss function fitting line. The corresponding box plot shows the interquartile range with the marked mean value (open square inside), the median (transverse line inside) and the error bar. The air-floating Ag membrane interface presents a well-defined mechanical characteristic of the typical air-solid interface, featuring a much smaller AFM tip-interface adhesion force, a notably increased interfacial stiffness and a substantially shorter rupture distance in comparison with that of the air-water interface. These evidences confirm that the as-prepared Ag membrane is definitely floating on the aqueous surface with no liquid-water layer above it.

FIGS. 9A-9B. | Structural characterizations of the (quasi-) bicontinuous Ag membrane. Digital photo (FIG. 9A) and transmission optical microscopic image (FIG. 9B) of the (quasi-)bicontinuous Ag membrane suspended by a varnished wire ring. Under transmission white light, the membrane with sub-visible-wavelength holes exhibits a selective optical transmittance of short-wavelength light, giving it a blue-violet appearance. The consistent colour without any detectable chromatic aberration demonstrates the largescale homogeneity of the (quasi-)bicontinuous structure. Scale bars are 5 mm (9A), 100 μm (9B).

FIGS. 9C-9E. TEM images of the Ag membrane suspended on the TEM copper grid obtained under different magnifications, evidently confirming its multiscale structural homogeneity. The inset in FIG. 9E is the corresponding selected-area electron diffraction pattern, showing the polycrystalline nature. Scale bars are 20 m (9C), 2 μm (9D), 200 nm (9E).

FIG. 9F. Illustration of the image-processing procedure for anisotropic analysis of the (quasi-)bicontinuous structure in a typical TEM image (FIG. 9D). Binary conversion was first performed on the image with the empty portions set to transparent. A copy of the processed image was then stacked on the original one and allowed to undergo a continuous clockwise rotation around the image centre. Through our customized Python image-processing code, the stacked part of the two square images at a specific rotation angle of θ was extracted by using their inscribed circle to calculate the geometric permeability (the ratio of the area of the overlapped through holes to the whole circle area).

FIG. 9G. Rotation angle θ-dependent geometric permeability of the stacked (quasi-)bicontinuous structure. The step size of θ is 0.5°.

FIG. 9H. Area distribution of the projected through holes of the stacked structure at the selected rotation angles. The density of the strips represents the frequency and the right curve shows the result of the frequency statistic. The dashed red line indicates the peak position of each distribution curve, highlighting the structural isotropy.

FIG. 9I. TEM image of the practical stacked two-layer (quasi-)bicontinuous Ag membrane (right) compared with the single-layer counterpart (left). The stacking operation demonstrates a simple strategy to adjust the through-hole sizes in the membrane by using the (quasi-) bicontinuous structure. Scale bar is 10 μm.

FIG. 9J. Statistical map of the circularity against the logarithmic area for the through holes in the one-layer and two-layer regions in FIG. 9I. The top plot is the density distribution along the axis of the through-hole area, showing a substantial decrease in both the hole size and the size dispersion after the stacking operation. The right box charts show the statistical result of the circularity of the through holes. The caps indicate the 3× interquartile range. Every box shows 25th-75th percentiles, with the marked median (transverse line inside) and mean (dot inside).

FIG. 10A. | Typical twist boundaries in the (quasi-)bicontinuous Ag membrane viewed from a direction parallel to the boundary. TEM image of the overall membrane network. Scale bar is 500 nm.

FIG. 10B. Size distribution of the grains in the membrane compared with that of the initial floating particles. Two hundred well-defined grains distinguished by the diffraction contrast were counted. The two distributions are nearly identical, evidently confirming that the membrane is derived from the assembly of the initial isolated particles instead of an epitaxial growth based on the sliver atom deposition.

FIG. 10C. Magnified TEM image of the marked region in FIG. 10A, visually showing the plentiful grain boundaries in the membrane network. Scale bar is 50 nm.

FIG. 10D-10E. High-resolution transmission electron microscopy image (FIG. 10D) of the marked region with small curvature in c and its corresponding pseudo-coloured counterpart (FIG. 10E), which highlights the three grains (A, B and C) with two visual grain boundaries (60°/[0-11] between grains A and B, 60°/[−1-10] between grains B and C). The two dashed squares in FIG. 10D mark the well-defined cross-boundary regions (that is, square 1 marks the boundary between grains A and B and square 2 marks that between grains B and C). The black arrows indicate the reactive amorphous surface with about 2 nm thickness. Scale bar is 5 nm (10D).

FIGS. 10F-10I. FFT images (FIG. 10F, FIG. 10H) and the corresponding Fourier-mask filtered (twin-oval pattern, edge smoothed by five pixels) images (FIG. 10G, FIG. 10I) for the square-marked regions 1 and 2 in FIG. 10D, respectively. The reciprocal vectors in the FFT image were labelled by using the same colours with their mother grains. Note the crystal indices labelled with ‘ ’ denote that these lattice planes should be absent in the reciprocal space owing to the crystallographic extinction rule, which are identifiable in the direct space in the high-resolution transmission electron microscopy image obtained under an appropriate Scherzer defocus. The white lines in FIG. 10G and FIG. 10I depict the twist boundary plane.

FIGS. 11A-11L. | Various factors that influence the capillary-attraction driven kinematics between two floating particles. FIGS. 11A-11D Influence of the particle size (variable R1 is from 10 to 99.99 m) on the kinematics at L0=400 μm, k=3, ρ=8,000 kg m-3 and ε=0.05. FIG. 11E-11H Influence of the initial distance (variable L0 is from 100 to 1,000 μm) on the kinematics at R1=20 μm, k=3, ρ=8,000 kg m-3 and ε=0.05. FIGS. 11I-11L Influence of the diversity factor (variable k=R2R1−1 is from 1 to 10) on the kinematics at L0=500 μm, R1=40×10−6, ρ=8,000 kg m-3 and ε=0.05. FIGS. 11A, 11E, 11I Time-dependent distance between the two floating particles in the capillary-attraction-driven acceleration process. FIGS. 11B, 11F, 11J Proportion of the displacement of the smaller particle to the initial distance when the two particles mutually collide. FIGS. 11C, 11D, 11G, 11H, 11K, 11L Time-dependent velocity for smaller particle (v1; FIGS. 11C, 11G, 11K) and bigger particle (v2; FIGS. 11D, 11H, 11L). Note that v1 and v2 are in opposite sign, indicating their relative movement under capillary attraction.

FIG. 12A. | Further evolution of the membrane after the formation of the bicontinuous 2D network. Digital photograph of the aqueous system for AgCl membrane synthesis at the emergence of a whole (quasi-)bicontinuous network. The marked regions 1 and 2 highlight the marginal and internal regions of the floating solid network, respectively. Scale bar is 1 cm.

FIGS. 12B-12C. Representative digital photograph of the marginal region of the (quasi-) bicontinuous AgCl network (FIG. 12B) and the corresponding map from the velocity-field analysis (FIG. 12B). The colour shows the local vorticity direction and intensity as indicated in the right colour bar. Scale bar is 500 μm (12B).

FIGS. 12D-12E. Digital photographs (FIG. 12D) recording the change of the internal region in the bicontinuous network after continuous particle trapping in 36 s and the time-course spatial distribution of these trapped nascent AgCl particles (FIG. 12E). Scale bar is 200 μm (FIG. 12D).

FIG. 13A. | Evolution of the through holes in connectivity and geometry during membrane network growth. Sequential microscopic images (obtained 6, 10, 26 and 35 min from the beginning of the reaction) recording the evolution of the AgCl membrane from the moment of forming (quasi-)bicontinuous structure (about 6 min). Scale bar, 200 μm.

FIG. 13B. Connectivity analysis of seven selected holes in the corresponding images in FIG. 13A. These selected regions are coloured and numbered as indicated on the right for the convenience of observation on the evolution in the hole's geometry and connectivity. Note that almost all the holes are interconnected and impartible in the original (quasi-)bicontinuous structure.

FIG. 13C. Calculated map obtained from the difference set between the microscopic images taken at 35 and 26 min, showing the locations of these trapped AgCl nascent particles during this period. The image is coloured blue to improve the visual contrast. Macroscopically, all of the hole boundaries have a nearly identical rise in thickness, implying that the new AgCl particles are randomly trapped by the solid network and there is little possibility of generating new Brownian clusters in the hole region.

FIG. 13D. Spatial evolution mapping of a representative hole (no. 1) during 26 to 35 min. The length and direction of the black arrows representatively show the maximum shrink rate and orientation of the hole at different boundary regions. The hot colour map highlights the vorticity of the shrink rate caused by the difference in the shrink orientation. The inset is the thin-plate spline analysis of differential evolution of the hole to visualize its shape changes in different areas.

FIG. 13E. Distributions of the velocity magnitude and the tangent velocity along the hole boundary in FIG. 13D. These parameters were extracted clockwise along the hole boundary from the start point indicated by the white arrow in FIG. 13D.

FIG. 14A. | Foolproof synthetic guidance to an unexplored inorganic membrane in our proposed SLIS system. Step-by-step flow chart to guide the synthesis of an inorganic membrane.

FIG. 14B. Summary of the initial conditions for creating the membranes in the presented library and the corresponding distributions based on 2D kernel density estimation, offering experiential choice of the initial concentration and temperature for different reaction categories.

FIGS. 14C-14F. Results of the kinematic simulations for the CN (FIG. 14C), ON (FIG. 14D), NI (FIG. 14) and CI (FIG. 14) phases. Note that these isolated particles are in grey and turn into blue once they are physically connected.

FIG. 14G. 2D kernel density estimation map of the membrane locations in a customized space, which consists of the terminal reaction time-to-critical time ratio and the membrane thickness-to-building unit size (vertical dimension) ratio. All the data were derived from the 40 kinds of membrane in the presented library. The dot density is indicated by the top colour bar. The box chart shows the statistical result of the membrane thickness-to-building unit size (vertical dimension) ratio. The caps indicate the 1.5× interquartile range. The diamond box shows 10th-90th percentiles, with the marked median (transverse line inside) and mean (dot inside). The empirical deviation coefficient ω, which represents the statistical ratio of the SLIS-mediated membrane thickness to the building unit size (vertical dimension), is determined to be between 1.06 and 5.94 by the box range.

### DETAILED DESCRIPTION

The present disclosure provides a method of fabricating an inorganic membrane, comprising coalescing inorganic particles at an air-liquid interface of a vessel in order to form the inorganic membrane,
wherein inner walls of the vessel is configured to repel the inorganic nanoparticles.

In some embodiments, the inorganic particles are coalesced via self assembly. In some embodiments, the inorganic particles are coalesced via Brownian motion and capillary attraction (Cheerios effect). In some embodiments, the inorganic particles are inorganic nanoparticles. In some embodiments, the inorganic particles are firstly coalesced via Brownian motion to form inorganic clusters. The inorganic clusters are then coalesced via capillary attraction (Cheerios effect) to form the inorganic membrane. This may occur simultaneously as the inorganic particles may be continuously generated from a solution mixture in the vessel and the agglomeration of the inorganic particles and inorganic clusters are only limited by the inter-particular physical interaction depending on their size.

The nanoparticles may have a size of about 2 nm to about 1000 nm. In other embodiments, the particle size is about 2 nm to about 900 nm, about 2 nm to about 800 nm, about 2 nm to about 700 nm, about 2 nm to about 600 nm, about 2 nm to about 500 nm, about 2 nm to about 400 nm, about 2 nm to about 300 nm, about 2 nm to about 200 nm, about 2 nm to about 100 nm, about 2 nm to about 50 nm, or about 2 nm to about 20 nm.

The clusters may have a size of about 0.5 μm to about 100 μm. In other embodiments, the cluster size is about 0.5 μm to about 90 μm, about 0.5 μm to about 80 μm, about 0.5 μm to about 70 μm, about 0.5 μm to about 60 μm, about 0.5 μm to about 50 μm, about 0.5 μm to about 40 μm, about 0.5 μm to about 30 μm, about 0.5 μm to about 20 μm, or about 0.5 μm to about 10 μm.

The inorganic particles are configured to coalesce at the air-liquid interface of the vessel. In this regard, the vessel comprises a solution. The vessel is also configured such that interaction of the inorganic particle with the inner wall of the vessel (liquid-solid interface) is not favoured. This may be done by decreasing the conformational entropy as the inorganic particle approach the inner wall. For example, the conformational entropy may be decreased by configuring the inner wall to have a low adhesion to the inorganic particles. The inner wall may be configured to have a low surface energy. For example, the inner wall may comprise a material with a surface energy below 36 dynes/cm. Examples of such material include, but is not limited to, polytetrafluoroethylene (PTFE), fluoropolymer, polyvinyl fluoride, polypropylene, polyethylene, ethylene-vinyl acetate (EVA), poly(vinyl acetate), polystyrene acetate, polyvinyl alcohol, and derivatives thereof.

In some embodiments, the inner wall comprises a coating of a low adhesion material. In some embodiments, the inner wall comprises a coating of a low surface energy material.

In some embodiments, the coating is characterised by a thickness of at least about 1 μm. This ensures that the coating is at least homogenously coated on the inner wall. Further increasing the thickness does not affect its efficacy of solid-liquid-interface shielding.

In some embodiments, the inner wall comprises a polymer. In some embodiments, the inner wall comprises a hydrogel. The hydrogel may be poly(vinyl acetate) or a derivative thereof. In particular, the poly(vinyl acetate) may be partially hydrolysed. In some embodiments, the inner wall comprises poly(vinyl alcohol-co-vinyl acetate) (PVAAc). It was found that when the hydrogel contacts with water, it expands to provide an elastic filament layer facing the fluid. This is advantageous for increasing the repulsion of inorganic particles to the inner wall. The elastic filament layer represents dense and partially free PVAAc molecular chains, with one end anchored to the modifying layer, and the other end extending into the aqueous solution by forming hydrogen bonds with water molecules. In brief, they can act like springs, compressing as inorganic particles approach, leading to an increase in elastic potential energy of the elastic filament layer and thus repulsion towards nearby particles.

When the coating is poly(vinyl alcohol-co-vinyl acetate) (PVAAc), the degree of hydrolysis may be about 70% to about 90%, or about 75% to about 90%. It was found that if the hydrolysis degree is too high, the PVAAc coating will dissolve into the aqueous solution. If the hydrolysis degree is too low, the coating cannot swell rapidly and effectively in the aqueous solution.

Other polymers that exhibit rapid water absorption and swelling properties at mild temperature may also be used, such as polyacrylamide (PAAm), polyacrylic acid (PAA), poly(N-isopropylacrylamide) (PNIPAAm), polyethylene glycol (PEG), or a combination or derivative thereof.

In some embodiments, poly(vinyl acetate) or a derivative thereof is characterised by a Young's modulus (compression) of about 0.1 MPa to about 0.2 MPa. In some embodiments, the elastic filament layer is characterised by a Young's modulus (compression) of about 0.02 MPa to about 0.08 MPa.

In some embodiments, poly(vinyl acetate) or a derivative thereof is characterised by a molecular weight of about 1400 g/mol to about 2000 g/mol.

In some embodiments, the inner wall comprises a coating having a concentration of about 1×10⁻² mg mm⁻² to about 3×10⁻² mg mm². In other embodiments, the concentration is about 1×10⁻² mg mm⁻² to about 2.8×10⁻² mg mm⁻², about 1×10⁻² mg mm⁻² to about 2.6×10⁻² mg mm⁻², about 1×10⁻² mg mm⁻² to about 2.4×10⁻² mg mm⁻², about 1×10⁻² mg mm⁻² to about 2.2×10⁻² mg mm⁻², about 1×10⁻² mg mm⁻² to about 2×10⁻² mg mm⁻², about 1×10⁻² mg mm⁻² to about 1.8×10⁻² mg mm⁻², or about 1×10⁻² mg mm⁻² to about 1.6×10⁻² mg mm⁻².

In some embodiments, the inorganic particles are formed via precipitation, hydrolysis or redox reaction.

The precipitation of a compound may occur when its concentration exceeds its solubility. This can be due to temperature changes, solvent evaporation, or by mixing solvents. Precipitation occurs more rapidly from a strongly supersaturated solution. The formation of a precipitate can be caused by a chemical reaction. For example, when a barium chloride solution reacts with sulphuric acid, a white precipitate of barium sulfate is formed. For example, when a potassium iodide solution reacts with a lead(II) nitrate solution, a yellow precipitate of lead(II) iodide is formed.

Hydrolysis is a chemical reaction in which a molecule of water breaks one or more chemical bonds. The term is used broadly for substitution, elimination, and solvation reactions in which water is the nucleophile.

Redox is a type of chemical reaction in which the oxidation states of a reactant change. Oxidation is the loss of electrons or an increase in the oxidation state, while reduction is the gain of electrons or a decrease in the oxidation state.

In some embodiments, the inorganic particles are selected from the group consisting of elemental entities, oxides, sulfides, halides, hydroxides, metallates, nonmetallates and coordination polymers. Five representative materials for each of the eight kinds of material are exemplified. In some embodiments, the inorganic particles comprises ammonium, titanium(iv), aluminium, calcium, manganese(ii), iron(iii), nickel(ii), copper(ii), cadmium, barium, copper(I), iodide, gold(iii), ruthenium(iii), palladium(ii), platinum(iv), hexacyanoferrate(iii), cobalt(ii), aluminate, metavanadate, chromate, molybdite, tetrathiotungstate, hydrogen carbonate, silicate, sulfite, thiosulfate, persulfate, zinc, silver, lanthanum(iii), cerium(iii), dysprosium(iii), samarium(iii), lead(ii), bismuth(iii), tungsten, L-ascorbic acid, tannic acid, oleamide, hexamethylenetetramine, 2-methylimidazole, dimethylglyoxime, derivatives or a combination thereof.

In some embodiments, the inorganic particles are selected from elemental substances (S, Pd, Ag, Pt and Au), oxides (TiO₂, MnO₂, RuO₂, CeO₂ and WO₃), sulphides (FeS, Cu₈S₅, ZnS, Dy₂S₃ and WS₂), halides (SmF₃, AgCl, BaClF₃, CuBr and PbI₂), hydroxides (Al(OH)₃, FeOOH, Cu(OH)₂, Cd(OH)₂ and La(OH)₃), metallates (Zn(AlO₂)₂, BiVO₄, Ag₂CrO₄, CaMoO₄ and In₂SnO₅), nonmetallates (CaCO₃, Zn₂SiO₄, Mg₃(PO₄)₂, Cu₂SO₃ and Ag₂SeO₃) and coordination polymers (KPB, K-containing Prussian blue; Fe-taa, Fe(iii)-polyphenol tannic acid complex; ZIF-67; Ni-dmg, Ni(ii)-dimethylglyoxime complex and Cu-oxa, Cu(ii)-oxalic acid complex).

In some embodiments, the inorganic particles are formed at an air-liquid interface of an aqueous medium. The term ‘aqueous medium’ used herein refers to a water based solvent or solvent system, and which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate.

For example, the inorganic particles may be formed when a first solution comprising a first inorganic precursor is mixed with a second solution comprising a second inorganic precursor in the vessel. The first inorganic precursor reacts with the second inorganic precursor to form the inorganic particles. For example, is the inorganic membrane is a silver membrane, Tollens' reagent (first solution) may be mixed with a second solution containing D(+)-glucose and NaOH.

In some embodiments, the inorganic membrane is selected from elemental substances (S, Pd, Ag, Pt and Au), oxides (TiO₂, MnO₂, RuO₂, CeO₂ and WO₃), sulphides (FeS, Cu₈S₅, ZnS, Dy₂S₃ and WS₂), halides (SmF₃, AgCl, BaClF₃, CuBr and PbI₂), hydroxides (Al(OH)₃, FeOOH, Cu(OH)₂, Cd(OH)₂ and La(OH)₃), metallates (Zn(AlO₂)₂, BiVO₄, Ag₂CrO₄, CaMoO₄ and In₂SnO₅), nonmetallates (CaCO₃, Zn₂SiO₄, Mg₃(PO₄)₂, Cu₂SO₃ and Ag₂SeO₃) and coordination polymers (KPB, K-containing Prussian blue; Fe-taa, Fe(iii)-polyphenol tannic acid complex; ZIF-67; Ni-dmg, Ni(ii)-dimethylglyoxime complex and Cu-oxa, Cu(ii)-oxalic acid complex).

In some embodiments, the inorganic membrane is formable in an absence of agitation. In this regard, the solution in the vessel is allowed to stand without any disturbance.

In some embodiments, the inorganic membrane is formable in less than about 30 min. In other embodiments, the inorganic membrane is formable in less than about 35 min, about 40 min, about 45 min, about 50 min, about 55 min, or about 60 min.

In some embodiments, the inorganic membrane comprises a quasi-bicontinuous network of inorganic material. A bicontinuous structure is a bicontinuous partitioning in which each subvolume is filled with a distinct, not necessarily uniform composition or state of matter.

In some embodiments, the inorganic membrane is isotropic. This means that the inorganic membrane has a physical property which has the same value when measured in different directions.

In some embodiments, the inorganic membrane is multifractal. This means that the inorganic membrane is not monocrystalline. The inorganic membrane may be polycrystalline or amorphous. The inorganic membrane may comprise twist boundaries between the polycrystals. A twist boundary is caused by a rotation between two crystals of the same structure.

In some embodiments, the inorganic membrane is characterised by at least one through hole. In some embodiments, the inorganic membrane is characterised by a circularity and geometrical convexity. In other words, the inorganic membrane has a morphology which is round, and/or is characterised by convex morphology.

In some embodiments, the inorganic membrane is characterised by a thickness of about 50 nm to about 500 nm. In other embodiments, the thickness is about 50 nm to about 450 nm, about 50 nm to about 400 nm, about 50 nm to about 350 nm, about 50 nm to about 300 nm, about 50 nm to about 250 nm, or about 50 nm to about 200 nm. In some embodiments, the thickness is about 180 nm.

In some embodiments, the method further comprises a step of removing the inorganic membrane from the vessel. This may be done by removing the solution in the vessel to retain the inorganic membrane in the vessel. The inorganic membrane may then be washed with a solvent, such as an aqueous medium or organic medium. For example, deionised water or acetone may be used. The inorganic membrane may then be transferred to a substrate by contacting the inorganic membrane with the substrate.

### EXAMPLES

Membrane construction relies on two conditions: constraining the matter distribution in two dimensions and maintaining its geometric continuity. For example, ultrathin polymeric membranes can be prepared through interfacial polymerization (IP), typically performed at the gas-liquid interface, at which the reactive building blocks are continuously supplied and undergo a systematic aggregation. We sought to take inspiration from the IP and apply the concept to various inorganics to create freestanding inorganic membranes.

### Conversion of Nucleation Preference

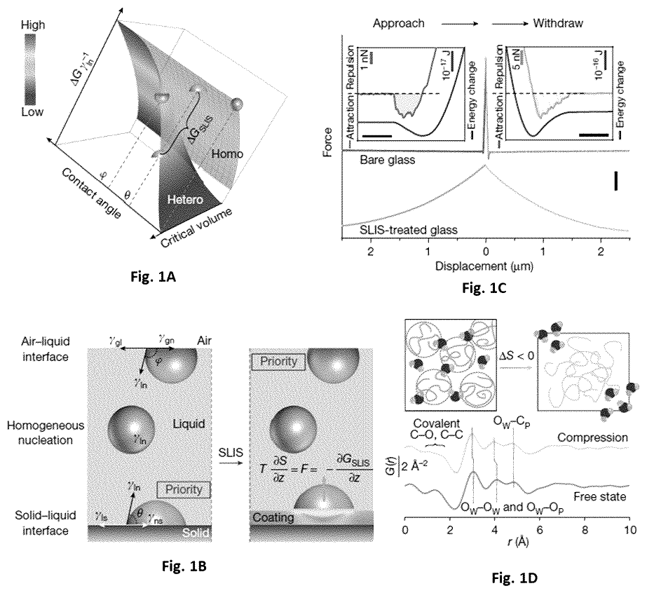

In a typical aqueous system for producing inorganic materials, owing to the lowest free energy barrier, solid nuclei formation on the vessel wall is preferred over that on the aqueous surface and homogeneous nucleation within the solution (FIGS. 1A-1B). Such undesired nucleation affinity, disclosed by exploring the force indentation curve on the interface using underwater atomic force microscopy (AFM), originates from the van der Waals attraction of the solid-liquid interface on adjacent solids, trapping them in a well-defined potential well (FIG. 1C). Regardless of the vessel materials, the interfacial potential well is identified in common aqueous systems. This discovery inspires us to devise a solid-liquid interface shielding (SLIS) strategy to shift the nucleation preference to the air-liquid interface, by simply using a hydrogel coating to raise the energy barrier for nucleation on the vessel wall (FIG. 1B).

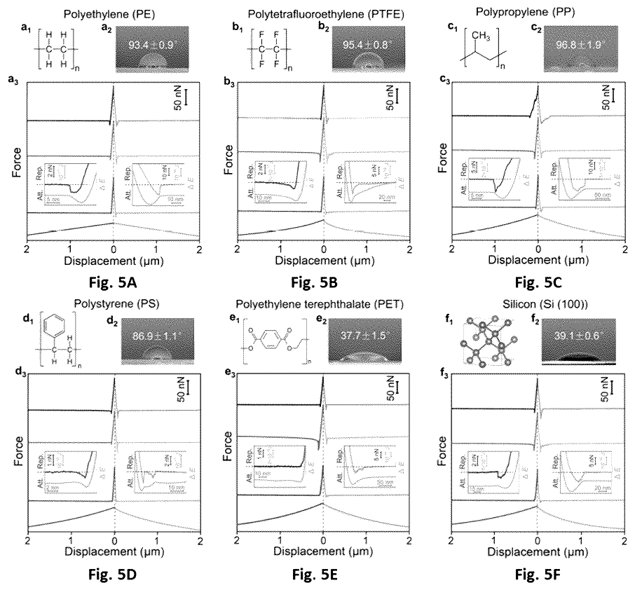

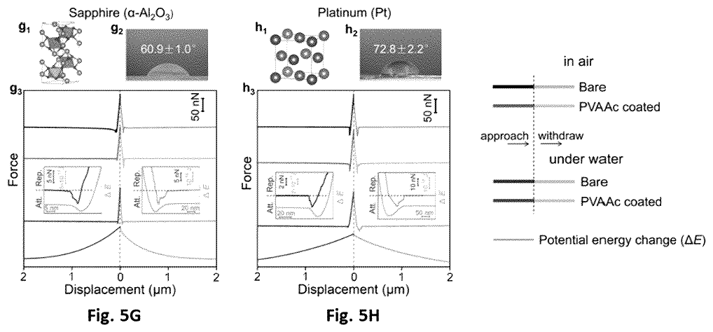

In this study, partially hydrolysed poly(vinyl acetate) (PVAAc) was used, which has alternating hydrophilic and hydrophobic areas, allowing its rapid swelling into a bulk hydrogel in the aqueous solution with an elastic filament layer facing the fluid. This hydrogel coat eliminates the potential well on the water-vessel interface and repels any approaching solid (FIG. 1C and FIGS. 5A-5H). Unveiled by the atomic pair distribution function (PDF) technique, the strategy can be described by a simple equation (equation (1)). Any approaching solids will cause a decrease in the conformational entropy (ΔS<0) of the coated hydrogel system (FIG. 1D). This produces a repulsive entropic force F (at the temperature of T and the resulting displacement of z) to inhibit their adhesion, which equivalently leads to an extra energy barrier (ΔGSLIS>0) on the solid-liquid interface from an energetic standpoint.

$$T \frac{\partial S}{\partial z} = F = - \frac{\partial {G}_{SLIS}}{\partial z} \qquad ( 1 )$$

### From Pilot Practice to a Membrane Library

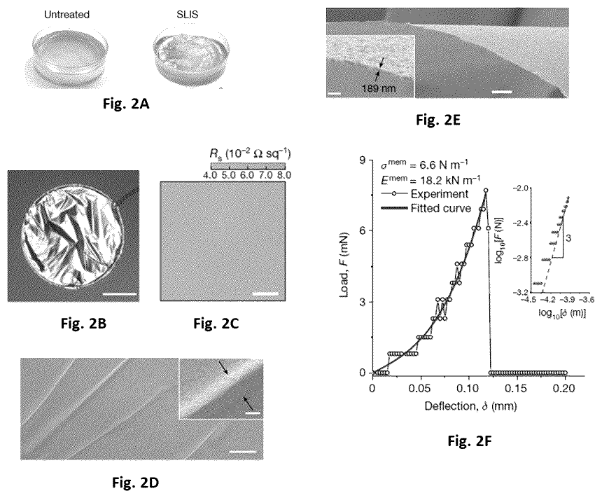

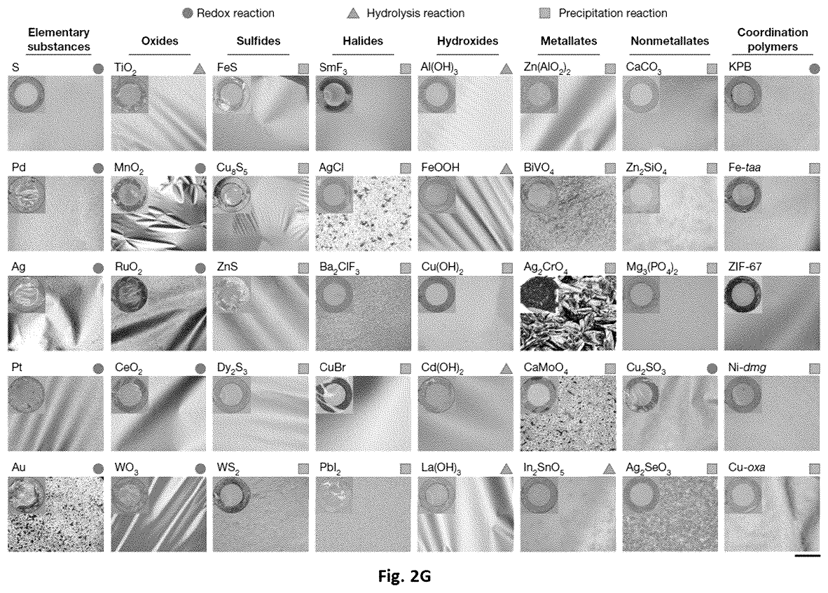

We then chose the silver mirror reaction, a well-known aqueous process for producing solid deposits on the vessel surface, as a pilot practice of the proposed SLIS strategy. When this classic reaction was performed in the PVAAc-coated vessel, a piece of shiny Ag membrane was directly obtained on the solution surface (FIG. 2A), which can be suspended by a varnished wire ring (FIG. 2B). The conductivity mapping (FIG. 2C) indicates its structural homogeneity in morphology, density and thickness at the macro scale. And the micro-level homogeneity was further confirmed by scanning electron microscopy (SEM; FIGS. 2D-2E). Moreover, the freestanding Ag membrane, just 189 nm in thickness, is of comparable Young's modulus (96.3 GPa) to its polycrystalline bulk counterpart (FIG. 2F). Meanwhile, the excellent flexibility is evidenced by the absence of fractures in these artificially created wrinkles with a bending radius of several micrometres (FIG. 2D).

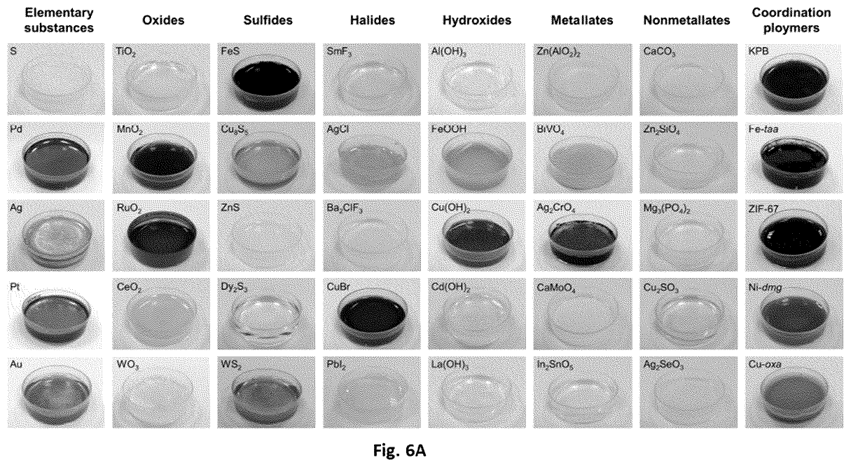

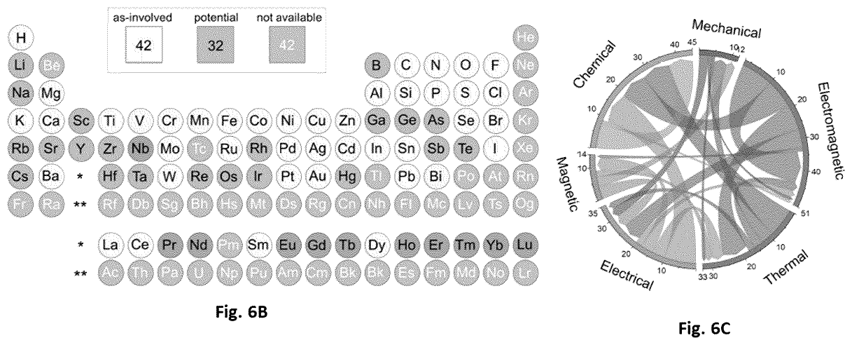

Beyond the initial success, the SLIS technique was further validated to be universal for the direct synthesis of various inorganic membranes at the air-liquid interface (FIG. 6A), even for those materials that are conventionally inconceivable, so long as the favourable reaction conditions for ensuring in-plane continuity were identified. The present membrane library involves 42 elements (FIG. 6B) and five representative membranes for each of the eight categories of classic materials (FIG. 2G), including elementary substances, oxides, sulfides, halides, hydroxides, metallates, nonmetallates and even coordination polymers, based on the three available types of aqueous reaction, that is, precipitation, hydrolysis and redox reaction. These inorganic membranes can reach several centimetres in dimension as determined by the vessel size and are uniform in thickness, typically ranging from tens of nanometres to several micrometres. Some transitional membranes of low-degree compactness have irregular through holes. Compared with their brittle bulk counterparts, most inorganic membranes are sufficiently thin to achieve a good degree of flexibility. In terms of serving as two-dimensional (2D) mediators for various energy couplings and/or conversions (FIG. 6C), these functional membranes promise diverse and intriguing applications oriented to the energy flows, such as optical filtering and acoustic damping.

### Kinematic-Controlled Membrane Growth

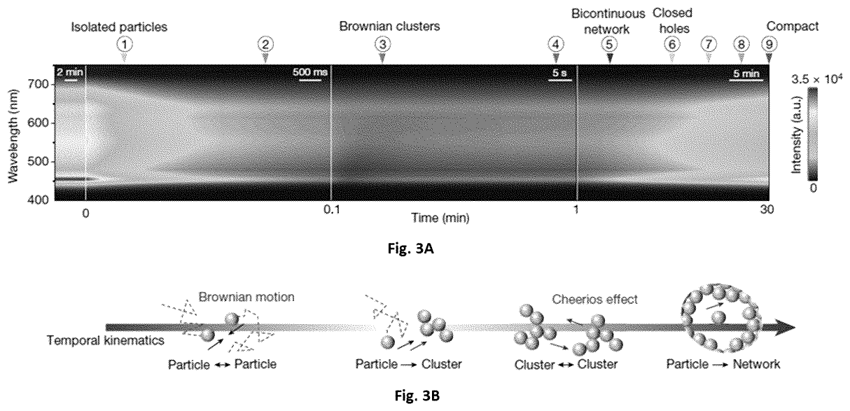

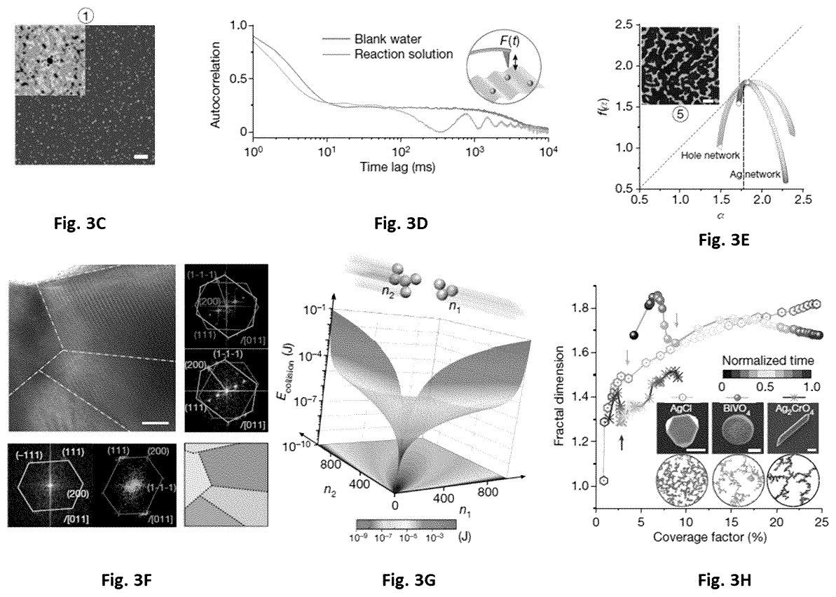

The SLIS technique merely enables the constraint of the building blocks at the air-liquid interface. However, it still lacks the guidance to establish their in-plane continuity, which consequently seeks to gain the insight into the membrane growth mechanism. By exploiting the size-dependent absorption and reflection of Ag, we developed a fast spectroscopic technique to identify all the critical structural evolutions (FIG. 3A). A successful membrane formation from the floating building blocks depends on two kinematics: Brownian motion that dominates the initial aggregation and the capillary attraction, known as the Cheerios effect that drives the subsequent self-assembly (FIG. 3B).

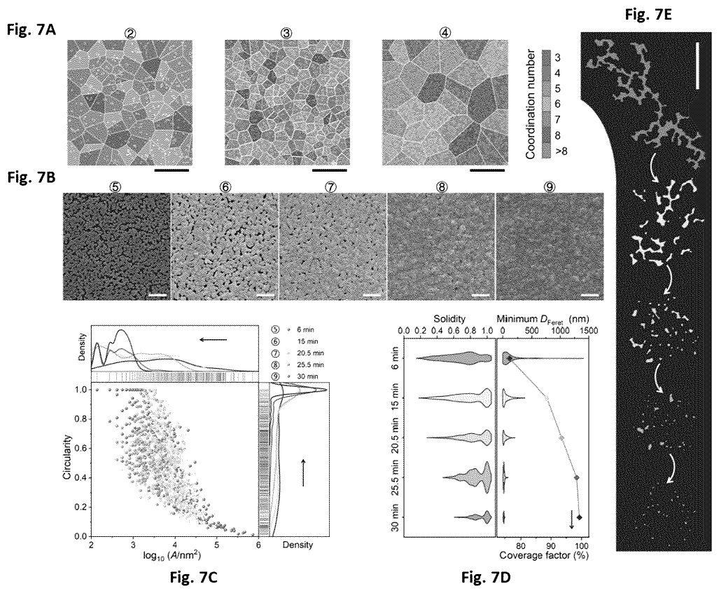

At an early stage after the reaction is initiated, numerous Ag nanoparticles are continuously supplied to the air-liquid interface (FIG. 3C). They are proved to float freely on the aqueous surface with in-plane Brownian motion by a customized AFM technique (FIG. 3D). These isolated particles stick together and create larger particles when random collisions occur. Because the reduced random mobility increases the collision frequency, the larger particles thus act as the seeds and transform into 2D Brownian clusters as time proceeds (FIG. 7A). This stage only lasts a few seconds as indicated by the rapid decrease in the interfacial reflectance.

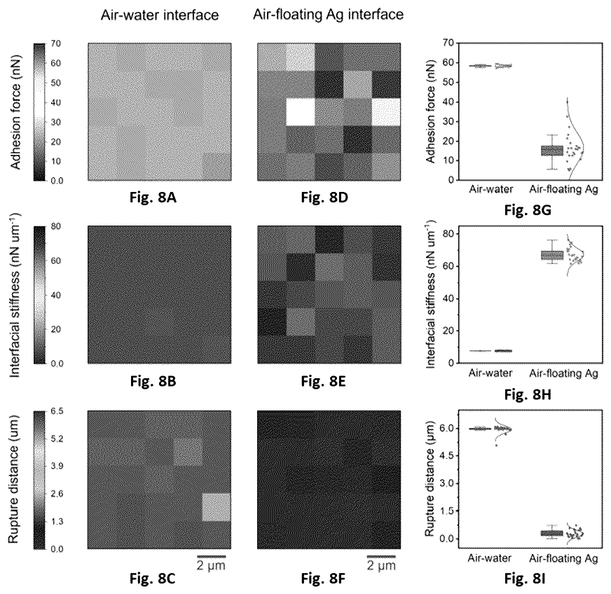

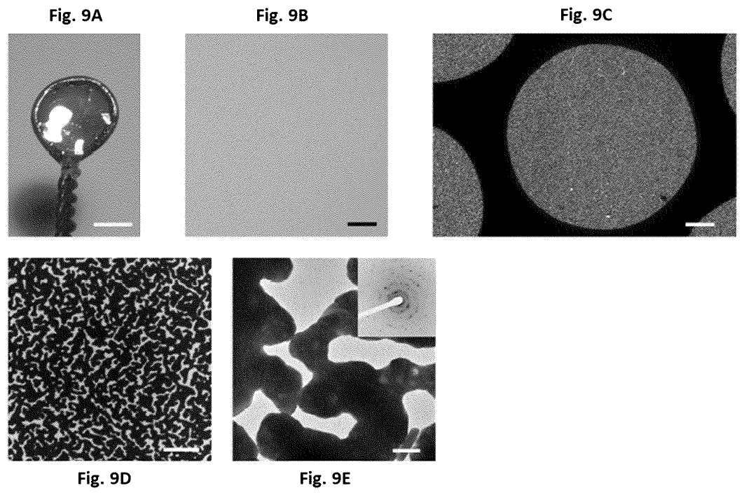

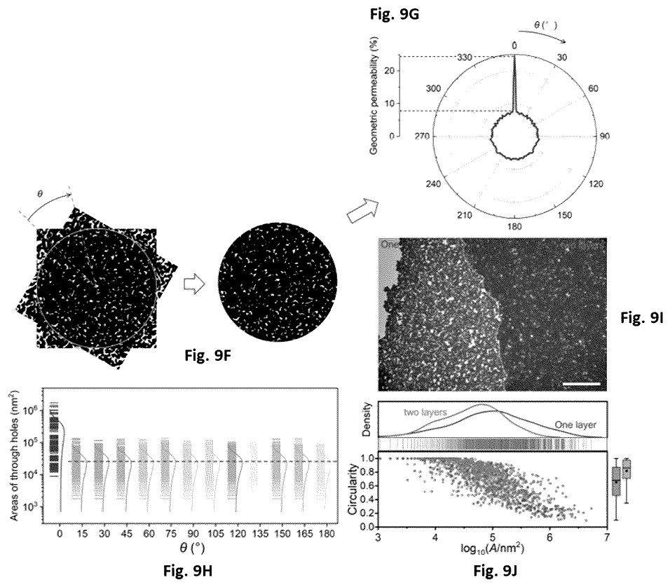

The evolution enters the second stage when the Brownian clusters are large enough, as the attractive capillary force between these solids in floating state (FIGS. 8A-8I) overwhelms their random Brownian motion. Driven by the Cheerios effect, these isolated Brownian clusters mutually attract and move to connect with the adjacent ones (FIG. 7A), until they reach a critical state of (quasi-)bicontinuous network (FIG. 3E and FIG. 7B). As it satisfies both the 2D matter distribution and the in-plane geometric continuity, this unique structure denotes the least criterion in geometry to define a freestanding membrane (FIGS. 9A-9J). The (quasi-)bicontinuous network is isotropic (FIGS. 9F-9J) and multifractal (FIG. 3E), shown by transmission electron microscopy (TEM), confirming that it derives from combined Brownian motion and the Cheerios effect rather than a single dynamic mechanism. Thereafter, with the dynamic capture of the nascent particles by the network, these meander-shaped vacant regions are progressively filled and evolved into well-defined closed through holes (FIG. 7B). Their circularity and geometrical convexity further increase with gradually reduced size and sharpened size distribution (FIGS. 7C-7E). This process causes a continuous increase in the interfacial reflectance, until the holey membrane becomes compact.

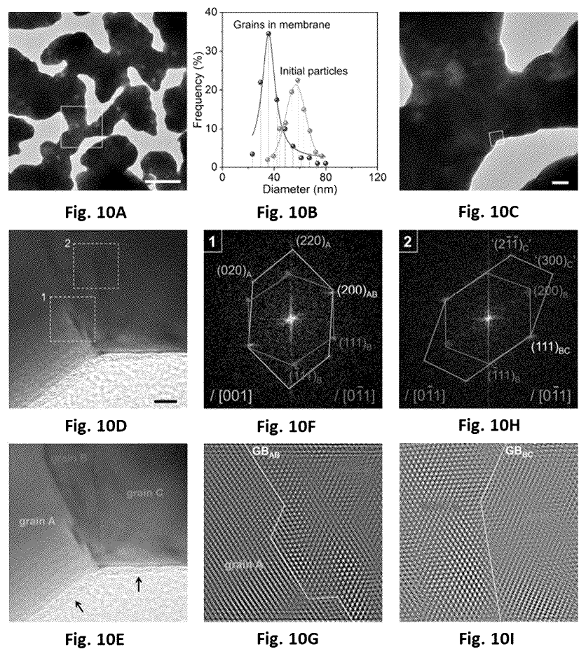

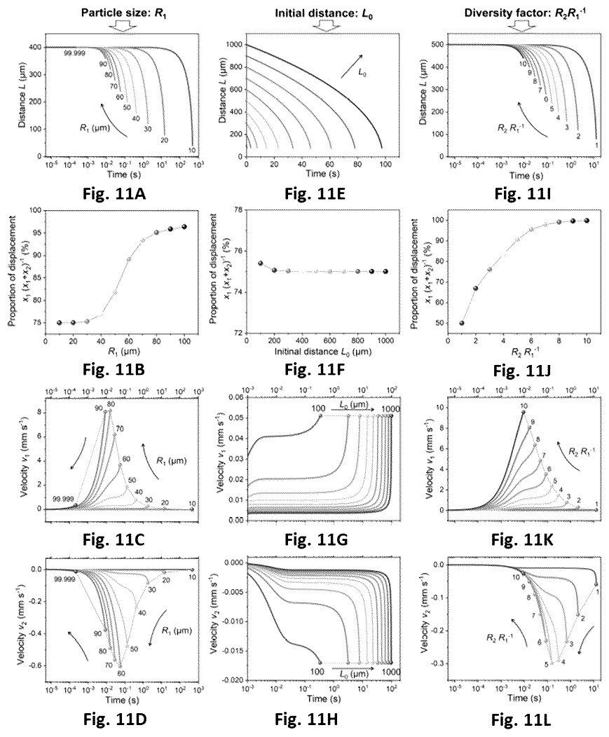

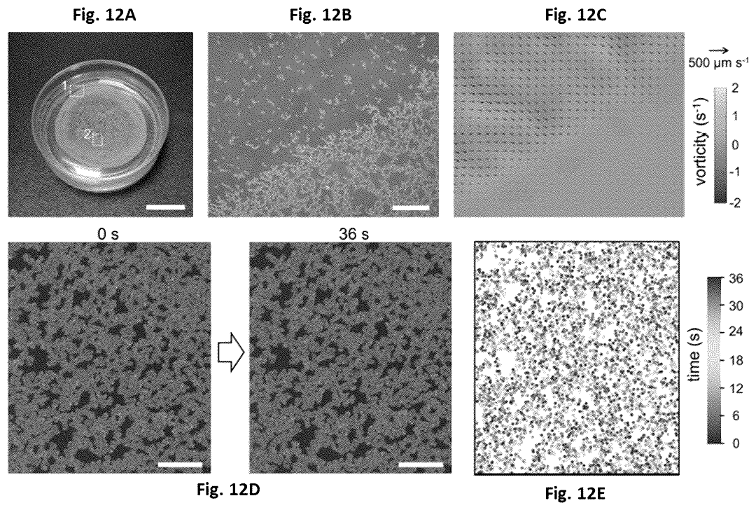

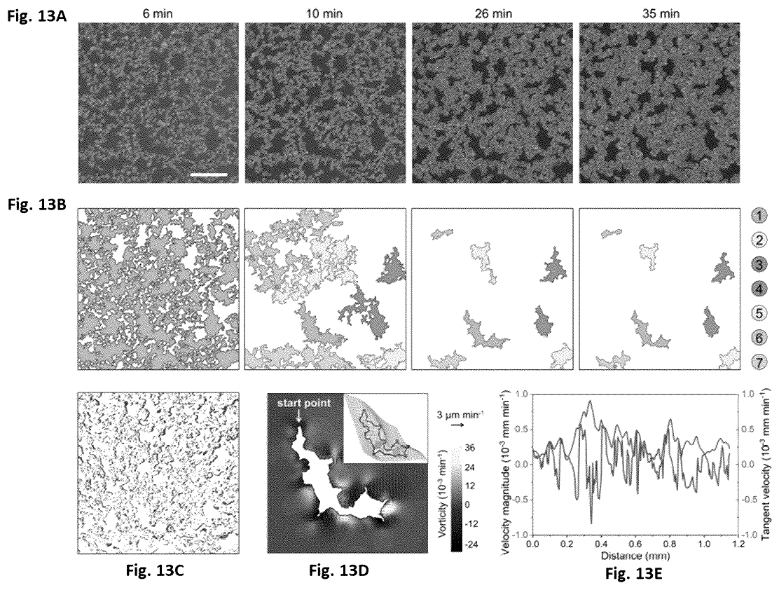

The impactful Cheerios-effect-driven collision contributes to the establishment of the physical connections, inferred from the plentiful twist boundaries observed in the polycrystalline Ag membrane (FIG. 3F, FIGS. 10A-10I). The collision energy for inducing such mechanical welding markedly intensifies as the size difference between the floating objects increases (FIG. 3G). All these findings concerning the dynamic membrane growth are consistently confirmed by the in situ observations on other membrane-forming systems involving various building blocks (FIG. 3H), regardless of component, size or dimension. Furthermore, experimental quantification of the kinematic parameters validates the theoretical prediction that, during the capillary-attraction-driven acceleration process, the smaller unit of an attractive pair is much more mobile than the bigger one (FIGS. 11A-11L). As a result, the evolution towards a compact membrane that occurs after the (quasi-) bicontinuous network can proceed without any kinetic obstacles. The outer edge of the network extends epitaxially by attracting the isolated particles/clusters (FIGS. 12A-12C). Meanwhile, the open vacancies inside the network are continuously separated into closed through holes at the high-curvature locations by the instantaneous capture of nascent particles (FIGS. 12D-12E and 13A-13E). The smooth evolution of the network provides the practical foundation to continuously adjust the through-hole ratio by simply controlling the reaction time.

### General Synthetic Methodology

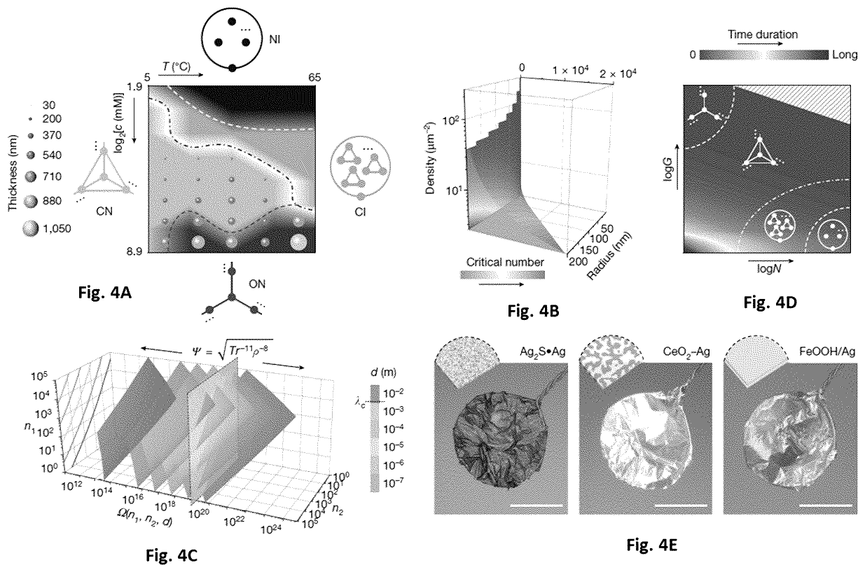

The understanding of the membrane growth process motivates our investigation into the synthetic methodology of any unexplored membranes in the complex dynamic system. We experimentally produce all the possible ultimate Ag patterns that emerge from various initial reaction conditions. This helps to construct a phase diagram based on graph theory (GT; FIG. 4A), a mathematical method that focuses on the geometrical connectivity and organization complexity. Accordingly, four distinct regimes depending on reaction concentration and temperature can be identified, that is, node islands (NI), clique islands (CI), open network (ON) and closed network (CN) in GT models. The first two are not membrane-forming phases, which correspond to the isolated particles and Brownian clusters in practice, featuring low graph density and small complexity index. For the other two regimes, successful membrane formation and adjustable thickness across a three-order-of-magnitude range can be achieved. Nevertheless, the CN phase presents a higher complexity index and much smaller thickness compared with the ON phase.

For the kinematic-controlled membrane growth (FIG. 3B), the recognizable phase boundaries depict the theoretical obstacles during the dynamic organization of the floating building blocks. Briefly, the floating particles maintain isolated and vigorous Brownian motion when they are tiny with low collision probability, thus forming a primitive NI phase. Only when this initial obstacle is surmounted (FIG. 4B) can these particles organize into growable Brownian clusters. Similarly, the following barrier is whether the clusters' capillary attraction is strong enough to compete with their random Brownian motion (FIG. 4C). If not, these clusters will remain isolated in the CI phase. If it is, these clusters, with high kinetic energy accumulating from the capillary force acceleration, can spontaneously interconnect into a network, forming the CN phase. Because Brownian motion and the Cheerios effect have inverse relationships with the increasing size of the floating solids, there should be an extreme situation when the initial building blocks are exceptionally large. They may bypass the Brownian motion stage and undergo direct self-assembly driven by capillary attraction, resulting in the ON phase with low graph density. Further kinematic simulation provides an intuitive understanding on the dynamic formation of these GT phases.

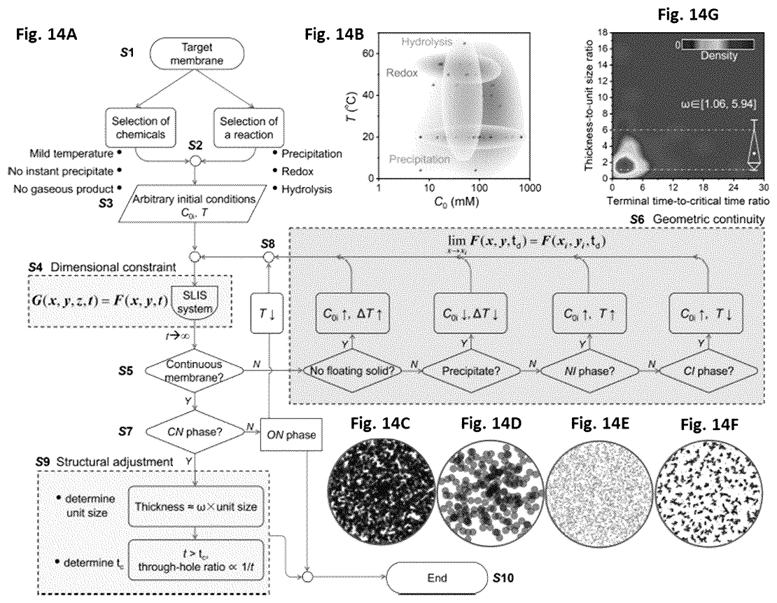

As the phase boundaries are theoretically determined by the size and density of the building blocks (FIGS. 4B-4C), a qualitative phase diagram can be derived (FIG. 4D) for these GT phases from the perspective of reaction kinetics, which underpins a general guidance for preparing the unexplored inorganic membranes in the SLIS system (FIGS. 14A-14G). Briefly, for a targeted inorganic production in a mild aqueous reaction, its corresponding membrane synthesis can simply begin with an arbitrary initial concentration and reaction temperature. By evaluating the GT-phase attributes of the floating solids after sufficient time has passed, one can accordingly adjust the reaction conditions of a new synthesis. After a repetition of the prescribed experimental loop (FIG. 14A), a well-defined membrane can be readily obtained, whose thickness and through-hole parameters can be further tuned by controlling the building unit size (FIG. 14G) and the terminal reaction time (FIGS. 7B-7E), respectively.

### CONCLUSION

Different from the IP process, the interfacial inorganic membrane emerges from a complex particle system, which involves several dynamics and multibody interactions. Under favourable configuration, these chaotic floating building blocks spontaneously evolve into various elegant and tangible structures. Beyond the presented membrane library, the work broadens the scope of the traditional conception of membrane from several perspectives: in composition, access to any unexplored membrane from the aqueous system is made possible by our general synthetic guidance. Moreover, the membrane variety will further enrich when the SLIS strategy is expanded to organic or melt systems. In structure, the multiplex membranes with diverse topological structures are proposed in contrast to the simplex ones (FIG. 4E). In functionality, the concept of the selective 2D barrier to conventional matter flow is extended to energy flow. These newly unlocked dimensions of inorganic membrane design act as a catalyst to rejuvenate the mature membrane technology.

### METHODS

### Materials and Reagents

Partially acetylated poly(vinyl alcohol) (poly(vinyl alcohol-co-vinyl acetate), PVAAc, 1,750±50, ≥99.0%) was purchased from Sinopharm Chemical Reagent Co., Ltd., China. Anhydrous D(+)-glucose (C₆H₁₂O₆, ≥99.5%), ammonium hydroxide (NH₃·H₂O, 28-30%), phosphoric acid (H₃PO₄, ≥85 wt %), sodium hydroxide (NaOH, ≥98.0%), ammonium fluoride (NH₄F, ≥99.99%), titanium(iv) fluoride (TiF₄), aluminium chloride

(AlCl₃, 99.99%), calcium chloride (CaCl₂, ≥99.9%), manganese(ii) chloride hydrate (MnCl₂·4H₂O, ≥98.0%), iron(iii) chloride (FeCl₃, 97%), nickel(ii) chloride (NiCl₂, 98%), copper(ii) chloride (CuCl₂, 99%), cadmium chloride (CdCl₂, 99.99%), barium chloride (BaCl₂, 99.9%), copper(I) bromide (CuBr, ≥98.0%), sodium iodide (NaI, ≥99.5%), gold(iii) chloride trihydrate (HAuCl₃·3H₂O, ≥99.9%), ruthenium(iii) chloride (RuCl₃), palladium(ii) chloride (PdCl₂, ≥99.9%), chloroplatinic acid hydrate (H₂PtCl₆·xH₂O, ≥99.9%), potassium hexacyanoferrate(iii) (K₃Fe(CN)₆, ≥99.0%), ammonium iron(iii) citrate ((NH₃)ₓFe_{y}C₆H₈O₇), cobalt(ii) acetate tetrahydrate (Co(CH₃COO)₂·4H₂O, ≥99%), manganese(ii) acetate tetrahydrate (Mn(CH₃COO)₂·4H₂O, ≥99%), sodium aluminate (NaAlO₂), ammonium metavanadate (NH₄VO₃, ≥99.0%), potassium chromate (K₂CrO₄, ≥99.0%), sodium molybdite (Na₂MoO₄, ≥98%), ammonium tetrathiotungstate ((NH₄)₂WS₄, ≥99.9%), potassium hydrogen carbonate (KHCO₃, 99.7%), sodium metasilicate pentahydrate (Na₂SiO₃·5H₂O, ≥95.0%), sodium sulfite (Na₂SO₃, ≥98.0%), sodium thiosulfate pentahydrate (Na₂S₂O₃·5H₂O, ≥99.5%), ammonium persulfate ((NH₄)₂S₂O₈, ≥98.0%), zinc sulfate heptahydrate (ZnSO₄·7H₂O, ≥99.0%), copper(ii) sulfate pentahydrate (CuSO₄·5H₂O, ≥98.0%), iron(ii) sulfate heptahydrate (FeSO₄·7H₂O, ≥99.0%), sodium phosphate tribasic dodecahydrate (Na₃PO₄·12H₂O, ≥98%), magnesium nitrate hexahydrate (Mg(NO₃)₂·6H₂O, 99%), silver nitrate (AgNO₃, ≥99.0%), lanthanum(iii) nitrate hexahydrate (La(NO₃)₃·6H₂O, 99.99%), cerium(iii) nitrate hexahydrate (Ce(NO₃)₃·6H₂O, 99.99%), dysprosium(iii) nitrate hydrate (Dy(NO₃)₃·xH₂O, 99.9%), samarium(iii) nitrate hexahydrate (Sm(NO₃)₃·6H₂O, 99.9%), lead(ii) nitrate (Pb(NO₃)₂, ≥99.0%), bismuth(iii) nitrate pentahydrate (Bi(NO₃)₃·5H₂O, ≥98.0%), tungsten powder (W, 99.95%), sodium hypochlorite solution (NaClO, available chlorine 4.00-4.99%), hypophosphorous acid solution (H₃PO₂, 50 wt % in H₂O), hydrazine hydrate (N₂H₄·xH₂O, 50-60%), L-ascorbic acid (C₆H₈O₆, ≥99.0%), tannic acid (C₇₆H₅₂O₄₆), oleamide (C₁₈H₃₅NO, ≥99%), hexamethylenetetramine (C₆H₁₂N₄, ≥99.0%), 2-methylimidazole (CH₃C₃H₂N₂H, 99%) and dimethylglyoxime (CH₃C(═NOH)C(═NOH)CH₃, ≥99.0%) were purchased from Sigma-Aldrich Inc. Hydrogen peroxide solution (H₂O₂, 30-32%) was purchased from QReC Chemical Co., Ltd. Hydrochloric acid (HCl, 37%), sulfuric acid (H₂SO₄, 98%) and nitric acid (HNO₃, 67-70%) were purchased from Thermo Fisher Scientific Inc. Deionized water used was prepared from a TKA water-purification system (Smart-2-Pure).

### Pretreatment on the Reaction Vessel

Without loss of generality, the consumable polystyrene Petri dish (Thermo Scientific, Φ=35×10 mm) was used as the reaction vessel for membrane synthesis. The inwall of the Petri dish was manually coated with the PVAAc film of about 1.6×10⁻² mg mm⁻², which can rapidly swell into a hydrogel coat once it makes contact with the aqueous solution. Briefly, the Petri dish was waggled sufficiently following the addition of 500 μl of PVAAc aqueous solution (3.5 wt %) to guarantee that all of its inwall surface was wetted by the solution. The pretreated Petri dish with PVAAc film coating was then obtained by desiccating it at 70° C. for 2 h, followed by naturally cooling down to room temperature.

### Membrane Preparation

The Ag membrane was prepared by performing the traditional silver mirror reaction in the SLIS system. Briefly, 1.5 ml of fresh Tollens' reagent solution (120 mM), which was prepared by adding 60 μl of ammonium hydroxide solution (28-30 wt %) into 1.44 ml of AgNO₃ solution, was first transferred into a pretreated Petri dish. After a subsequent addition of 1.5 ml of mixed solution containing D(+)-glucose (250 mM) and NaOH (50 mM), the mixture was left to stand at room temperature for 30 min. During this period, the reflective Ag membrane gradually formed on the aqueous solution surface. Finally, the Ag membrane was transferred onto the surface of the deionized water through a glass sheet. As a control, the synthesis was carried out in a clean Petri dish with no surface coating using the same reaction condition. Procedures for other membrane syntheses in the SLIS system are performed as per literature.

### Membrane Transfer, Suspend and Cut

To separate the floating membrane from the reaction Petri dish, the solution was first removed using a pipette, followed by adding 8 ml deionized water to refloat the membrane. The water inside the dish was further replaced three times to fully eliminate residual chemicals. The membrane-held dish was then gently immersed in a large tank (usually a glass container with a diameter of 12 cm and a height of 6 cm) full with deionized water, enabling the transfer of the cleaned membrane to a wider aqueous surface. To cut the membrane into the desired dimensions, it was lifted by a hydrophobic acrylic plate, quickly cut with a razor blade before the water completely evaporated and then released to refloat on the water surface for subsequent transfer. Regardless of substrate composition or surface topology, these water-floating membranes can be conveniently transferred to or suspended by a wide range of substrates, including silicon slice, acrylic plate, glass slide, copper ring, varnished wire ring and conductive carbon tape in facing different characterizations. To adapt to the membranes with varied degrees of hydrophobicity and then prepare the flat membrane for X-ray diffraction (XRD) characterization, an optional hydrophilic surface of the hydrophobic acrylic plate was created by exposing it to 254-nm ultraviolet (UV) light (Novascan PSD-UVT) at room temperature for 15 min. Instead of deionized water, the acetone solution (about 2-10 vol % in deionized water) was used to clean and float those membranes that were not water resistant.

### Structure Characterizations

SEM images were acquired on a JEOL JSM-7001F with a 15-kV electron beam equipped with a tiltable specimen stage. Energy-dispersive X-ray spectroscopy data were collected using an Oxford X-max 50 detector. One side of the small piece of freestanding membrane was fixed on the conductive carbon tape for cross-sectional SEM observation.

For energy-dispersive X-ray spectroscopy analysis, the membrane was transferred onto a flat silicon slice, copper foil or conductive carbon tape according to its chemical composition. TEM images were obtained on a JEM-2100F with a 200-kV electron beam and the conductive Ag membrane was directly supported on a bare copper grid. Fast Fourier transform (FFT) image processing was performed on DigitalMicrograph. The topography image of the membrane that is supported by a flat silicon slice was obtained on a Bruker JPK NanoWizard Sense AFM equipped with a AC240-PP tip (OPUS, nominal spring force constant of 2 N m⁻¹). The corresponding thickness measurement was performed on the JPKSPAM data-processing software. XRD patterns of membranes at room temperature were collected on a Bruker D8 ADVANCE at Cu Kα radiation (λ=1.54056 A) at a scanning rate of 4° min⁻¹ with the X-ray tube voltage of 40 kV and current of 25 mA. The preferred orientation of the membrane was identified by completely indexing the XRD pattern, calculating each of the enhancements in the relative intensities compared with the polycrystalline standard pattern after removing the background and recognizing the (h k l) value that corresponds to maximum enhancement. Fourier-transform infrared spectroscopy spectra were measured on a IRPrestige-21 spectrophotometer by using a Quest Single-Reflection ATR Accessory equipped with a standard diamond puck.

### Optical, Electrical and Wettability Characterizations

The diffuse reflectance UV-visible-near infrared spectrum was obtained on a Shimadzu UV-3600 spectrophotometer with the wavelength range of 250 to 2,500 nm. Room-temperature sheet resistance of Ag membrane was measured using a Keithley 2602 SourceMeter equipped with a M3TC four-point probe and a Zolix TSM13-1 X-Y mobile station. The sheet resistance mapping was obtained by performing the measurements over an area of 10×10 mm2 following a square 20×20 grid. Surface wettability test was performed at room temperature by placing 5 μl of sessile deionized water droplet on the substrate surface. On the basis of the side-view picture shot by an H1600 Industrial Camera equipped with S-EYE software, the relevant contact angle was determined using a specific plugin in ImageJ.

### Optical Observation of Freestanding Membranes

After a small piece of membrane with appropriate size (3 mm<dimension in each direction <4 mm) was cut from a whole one, it was released to refloat onto deionized water surface and then suspended over a copper ring with outer and inner diameters of 4 mm and 2 mm, respectively, to ensure a single-layer membrane. The through-hole membrane was used for optical observation on an Olympus BX53 microscope after natural drying at room temperature.

Mechanics of the as-Prepared Freestanding Ag Membrane

One face of the laser-cut polymethyl methacrylate ring (outer diameter Φ=11 mm, internal diameter 2R=5 mm and thickness h=3 mm) was first painted with a thin polydimethylsiloxane coat (mixture of polydimethylsiloxane base and curing reagent in a 10:1 ratio), followed by curing at 80° C. for 2 h. The coated side of the ring was then used to lift a water-floating Ag membrane with dimensions 12×12 mm, which was subsequently dried at 50° C. for 30 min. The indentation measurement was performed at the centre point of the membrane on a MultiTest 1-i tensile and compression test system (Mecmesin) by using a quartz rod (diameter Φ=1 mm) with a hemispherical head. Before the measurement, the static electricity on the polymethyl-methacrylate-ring-suspended membrane and the quartz rod were fully eliminated using a Milty Zerostat 3. The loading rate was 1 mm min⁻¹. The relation between the force F and the indentation depth δ is given by

$$F = {σ}^{mem} π R ( \frac{δ}{R} ) + {E}^{mem} {q}^{3} {R ( \frac{δ}{R} )}^{3} \qquad ( 2 )$$

$$q = 1.05 - 0.15 v - 0.16 {v}^{2} \qquad ( 3 )$$

in which R is the radius of the Ag membrane; σ mem is the membrane Young modulus and defined as σ mem=Et, with the Young modulus E and the membrane thickness t; σ mem is the pretension and defined as σ mem=σt, with the residual stress σ; and q is a dimensionless constant that is related to the Poisson's ratio v of silver (taken here as 0.37). The values of σ mem and a mem are obtained through curve fitting to the equation.

### In Situ Reflectance Spectra During Ag Membrane Formation

The acquisition of in situ reflectance spectra was carried out in a customized optical system. To exclude ambient light, the measurements were performed in a sealed cuboid box (160×100×70 mm³) with all faces painted black. After a pretreated dish containing 1.5 ml of fresh Tollens' reagent solution (120 mM) was placed inside in the central position, an incident light beam (visible fibre-coupled UHP-T-LED, Prizmatix) with a collimator 12 mm in diameter was fixed at 30 mm over the solution surface and set at a 90° angle from an opposite fibre detector of the spectrometer (Maya2000, Ocean Optics). To trigger the reaction, 1.5 ml of mixed D(+)-glucose (250 mM) and NaOH (50 mM) solution prestored in the dropper hanging over the apparatus was instantly introduced into the system and the in situ reflectance spectra of the air-liquid interface were consecutively collected through SpectraSuite. The spectra in five minutes before triggering the reaction were collected at a rate of 0.2 Hz to estimate the stability of this customized measurement. The acquisition rates were set at 16.7 Hz and 0.032 Hz, respectively, for the first 60 s and the remaining 29 min when the reaction was ignited. Critical time nodes were determined by mathematically identifying these moments containing extreme points of the recorded reflection intensity, which is a binary function of time and wavelength.

### Brownian Motion of the Floating Silver Particles

To determine whether the floating silver particles on the bulk solution surface have been exposed to the gaseous phase or are still completely immersed under the air-liquid interface, we developed an indirect technique based on the collection and analysis of the localized force signal on an Asylum MFP-3D system equipped with a PPP-CONTPt-50 probe (NANOSENSORS; nominal spring force constant 0.2 N m⁻¹). The probe was suspended over the solution with a constant amplitude at which the attraction between the water surface and the probe can be well detected but out of the jump-to-contact distance. As well as the intrinsic noise caused by the fluctuations of water surface, once any floating solid passed through the space between the solution surface and the probe, it would instantly diminish the attracting force that the probe measured. Such a disturbance D(t) would be well contained in the collected time series of force F(t) (converted from the amplitude signal) and strongly influence its autocorrelation result. At the time node of interest 1 s after initiating the silver mirror reaction in the SLIS system, the reaction was terminated by immediately replacing the reaction solution by equivoluminal deionized water. Besides the deionized water as a blank control, the aforementioned approach was performed on these particle/solution systems for 100 s with the collection frequency of 1,024 Hz. The subsequent autocorrelation analysis of the time series F(t) was performed by using the MATLAB built-in autocorrelation function (ACF) according to the following:

$$ACF ( τ ) = {\sum }_{t = τ + 1}^{n} \frac{( {F}_{( t )} - \overline{F} ) ( {F}_{( t + τ )} - \overline{F} )}{{\sum }_{t = 1}^{n} {( {F}_{( t )} - \overline{F} )}^{2}} \qquad ( 4 )$$

in which F̅ is the mean value of the collected time series and r is the time lag. There is a notable difference between the autocorrelation results for the cases of blank water surface and the particles-floated solution surface. The latter case presents oscillatory autocorrelation peaks at different timescales, which were further confirmed to be an intrinsic signal feature instead of originating from noise. These oscillatory autocorrelation peaks are derived from the modulation effect on the detected force by the probe when these air-exposed particles pass through the space between the solution surface and the probe. Evidently, these results confirm that these silver particles generated from the bulk solution have passed through the air-liquid interface and been exposed to the air. Furthermore, these floating particles remain in random 2D Brownian motion on the aqueous surface.

### AFM Measurements

AFM force-distance curves obtained from the indentation experiments were conducted on an Asylum MFP-3D scanning probe microscopy system equipped with a PPP-CONTPt-50 probe (NANOSENSORS; nominal spring force constant of 0.2 N m⁻¹). The actual spring force constants in different situations were calibrated by acquiring force-distance curves on a stiff glass surface. To obtain the coated substrate, 10 μl of PVAAc aqueous solution (3.5 wt %) was applied thoroughly onto the surface of the bare substrate (area 1×1 cm²) at 70° C. in an oven and then desiccated for 2 h. To measure the surface mechanical properties of various substrates in the aqueous system, the substrate was fixed at the bottom of a Petri dish (37×7 mm), followed by adding 3 ml of deionized water at room temperature to immerse it. The probe was then completely submerged to perform measurement after the water level was stabilized. All the force curves were recorded under the same loading and unloading rate of 1.5 m s⁻¹. The displacement

(x)-dependent potential energy change (ΔE) between x0 and x1 was obtained by using the recorded force curve F(x) according to the following equation:

$$Δ E = - {\int }_{{x}_{0}}^{{x}_{1}} F ( x ) dx \qquad ( 5 )$$

Force maps of the interfaces of interest, including the control air-deionized water interface and the interface between air and the on-site floating Ag membrane (30 min after igniting the silver mirror reaction in the SLIS system), were performed over an area of 10×10 m² following a square 5×5 grid. All the measurements were conducted at room temperature, the vertical indentation rate was 5 m s⁻¹ and the sampling frequency was 1 kHz. The adhesion force was determined by the lowest point of the retraction curve. The interfacial stiffness was determined by fitting the slope of the repulsive part of the approach curve. The rupture distance was calculated as the difference between the pull-off displacement and the snap-in displacement.

### PDF Analysis

One milliliter of deionized water was added onto the PVAAc coat (about 5×10⁻² mg mm⁻²) on a square glass plate (area 12×12 mm² and thickness 2 mm), followed by standing at room temperature for 15 min. When the dry PVAAc film fully swelled into the hydrogel coat, the free water was carefully removed by filter paper to prepare the free-swelling hydrogel coating. To obtain the compressive-state hydrogel counterpart, another piece of glass plate was covered on the free-swelling hydrogel coating, followed by applying a compressive load of 21.6 N on a Mecmesin MultiTest 1-i tensile and compression test system. The transudatory water was removed by filter paper during 10-min-retained compressive loading. XRD data of the two-state hydrogel coatings supported by glass substrate was collected on a Bruker D8 ADVANCE at Cu Kα radiation (=1.54056 A) with the 2θ degree range from 5° to 145° at a scanning rate of 2° min⁻¹. The X-ray tube voltage and current were 40 kV and 40 mA, respectively. The PDF was directly calculated from the measured total scattering function through Fourier transformation by using PDFgetX3.

### Fractal and Multifractal Analysis

The Minkowski-Bouligand dimension D of a fractal topological structure was determined through a classic box-counting method, according to the following equation:

$$D = {lim}_{ε \to 0} \frac{log N ( ε )}{log \frac{1}{ε}} \qquad ( 6 )$$

in which N(e) is the number of boxes of side length e required to cover the geometric structure. D is estimated as the exponent of a power law representing the fractal dimension of a certain structure. Moreover, the multifractal spectrum, also known as the singularity spectrum, namely, the relationship between the Hausdorff dimension f and the average singularity strength a, was used to identify heterogeneity of the kinetic process and quantify structural complexity, which was determined through a previously reported method according to the following implicit functions of the distorting exponent q:

$$α ( q ) = {lim}_{ε \to 0} \frac{{\sum }_{i = 1}^{N} \frac{{[ {P}_{i} ( ε ) ]}^{q}}{{{\sum }_{j = 1}^{N} [ {P}_{i} ( ε ) ]}^{q}} log [ {P}_{i} ( ε ) ]}{log ε} \qquad ( 7 )$$

$$f ( q ) = {lim}_{ε \to 0} \frac{{\sum }_{i = 1}^{N} \frac{{[ {P}_{i} ( ε ) ]}^{q}}{{{\sum }_{j = 1}^{N} [ {P}_{i} ( ε ) ]}^{q}} log \{ \frac{{[ {P}_{i} ( ε ) ]}^{q}}{{{\sum }_{j = 1}^{N} [ {P}_{i} ( ε ) ]}^{q}} \}}{log ε} \qquad ( 8 )$$

in which Pi(ε) is the probability (integrated measure) in the ith box of longitude ε, namely, a fraction of the amount of pixels in each box. The multifractal analyses were performed on both the (quasi-)bicontinuous solid network and the corresponding gaseous network, which were extracted from a typical SEM picture in advance through ImageJ.

### In Situ Observation of the Membrane Growth

The growth processes of AgCl, BiVO₄ and Ag₂CrO₄ membranes on aqueous surface were recorded using an H1600 Industrial Camera with the S-EYE software. The experiments were performed in a windshield box on a vibration isolator. The temperature was controlled by a bottom electronic heating plate. The reaction temperatures were 35° C.,

50° C. and 55° C. for AgCl, BiVO₄ and Ag₂CrO₄ membrane synthesis, respectively. A ring light-emitting diode was used in reflection mode as the lighting source. The vertical focal length was fixed in advance by focusing on the aqueous surface of 3 ml deionized water held in a pretreated Petri dish. After igniting the reaction by a quick addition of all the reactant solution, the kinematic evolution of the floating solids on the aqueous surface was simultaneously recoded at a frame rate of 30 frames per second with the resolution of 1,920×1,080 pixels. All of the video editing was performed in Shotcut. On the basis of the particle imaging velocimetry algorithm, the velocity field was calculated by performing correlation analysis on the positions of the floating particles between successive video frames using PIVlab written for MATLAB38. The thin-plate spline analysis of differential evolution of the hole was performed using PAST 4.09.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

What is claimed is:

1. A method of fabricating an inorganic membrane, comprising coalescing inorganic particles at an air-liquid interface of a vessel in order to form the inorganic membrane, wherein inner walls of the vessel is configured to repel the inorganic nanoparticles.

2. The method according to claim 1, wherein the method comprises coalescing the inorganic particles via Brownian motion to form inorganic clusters, and coalescing the inorganic clusters via capillary attraction (Cheerios effect) to form the inorganic membrane.

3. The method according to claim 2, wherein the inorganic particles are inorganic nanoparticles characterised by a size of about 2 nm to about 1000 nm, and
wherein the inorganic clusters are characterised by a size of about 0.5 μm to about 100 μm.

4. The method according to claim 1, wherein the inner wall is configured to have a surface energy of less than about 36 dynes/cm.

5. The method according to claim 1, wherein the inner wall comprises a coating of a polymer or a hydrogel.

6. The method according to claim 1, wherein the inner wall comprises poly(vinyl acetate), polyacrylamide (PAAm), polyacrylic acid (PAA), poly(N-isopropylacrylamide) (PNIPAAm), polyethylene glycol (PEG), or a derivative thereof.

7. The method according to claim 1, wherein the inner wall comprises poly(vinyl alcohol-co-vinyl acetate) characterised by a degree of hydrolysis of about 70% to about 90%.

8. The method according to claim 1, wherein when the inner wall comprises poly(vinyl acetate) or a derivative thereof, it is characterised by a molecular weight of about 1400 g/mol to about 2000 g/mol.

9. The method according to claim 1, wherein the inorganic particles are formed via precipitation, hydrolysis or redox reaction.

10. The method according to claim 1, wherein the inorganic particles are selected from the group consisting of elemental substances, oxides, sulfides, halides, hydroxides, metallates, nonmetallates and coordination polymers.

11. The method according to claim 1, wherein the inorganic particles are selected from S, Pd, Ag, Pt, Au, TiO₂, MnO₂, RuO₂, CeO₂, WO₃, FeS, Cu₈S₅, ZnS, Dy₂S₃, WS₂, SmF₃, AgCl, BaClF₃, CuBr, PbI₂, Al(OH)₃, FeOOH, Cu(OH)₂, Cd(OH)₂, La(OH)₃, Zn(AlO₂)₂, BiVO₄, Ag₂CrO₄, CaMoO₄, In₂SnO₅, CaCO₃, Zn₂SiO₄, Mg₃(PO₄)₂, Cu₂SO₃, Ag₂SeO₃, K-containing Prussian blue, Fe(iii)-polyphenol tannic acid complex, ZIF-67, Ni(ii)-dimethylglyoxime complex and Cu(ii)-oxalic acid complex.

12. The method according to claim 1, wherein the method further comprises mixing a first solution comprising a first inorganic precursor with a second solution comprising a second inorganic precursor in the vessel.

13. The method according to claim 1, wherein the inorganic membrane is formable in an absence of agitation.

14. The method according to claim 1, wherein the inorganic membrane is formable in less than about 30 min.

15. An inorganic membrane formed from the method according to claim 1, wherein the inorganic membrane comprises a quasi-bicontinuous network of inorganic material.

16. The inorganic membrane according to claim 15, wherein the inorganic membrane is isotropic.

17. The inorganic membrane according to claim 15, wherein the inorganic membrane is multifractal.

18. The inorganic membrane according to claim 15, wherein the inorganic membrane is characterised by at least one through hole.

19. The inorganic membrane according to claim 15, wherein the inorganic membrane is characterised by a circularity and geometrical convexity.

20. The inorganic membrane according to claim 15, wherein the inorganic membrane is characterised by a thickness of about 50 nm to about 500 nm.
